(19) United States
(12) Patent Application Publication
(10) Pub. No.: US 2006/0214777 A1
(43) Pub. Date: Sep. 28, 2006

(54) Medical device and method for remote maintenance of a medical device

(75) Inventor: Thomas Schmitt, Forchheim (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/387,678

(22) Filed: Mar. 23, 2006

(30) Foreign Application Priority Data
Mar. 24, 2005 (DE) 10 2005 013 852.7

(51) Int. Cl. G05B 11/01

(52) U.S. Cl. 340/310.11; 340/539.12

(57) ABSTRACT

The invention relates to a medical device and to a method for remote maintenance of a medical device. To allow an especially simple, secure and reliable transfer of data, it is proposed that a data transmission device for transmission of data over a power network be provided.

### CROSS REFERENCE TO RELATED APPLICATIONS

This application claims priority to the German Application No. 10 2005 013 852.7, filed Mar. 24, 2005 which is incorporated by reference herein in its entirety.

### FIELD OF INVENTION

The invention relates to a medical device and a method for remote maintenance of a medical device.

### BACKGROUND OF INVENTION

Data networks, e.g. telephone lines, Internet, and/or mobile radio connections are generally used for transmission of data in medical devices, especially for the purposes of remote maintenance. It can however be the case that such data networks at the location of the medical device are not available or are temporarily not available. The non-availability can for example be caused by a fault in the data network, an outage of an Internet server or insufficient radio coverage. There can be no guarantee that the data will always be transmitted securely and reliably. Around-the-clock availability of remote maintenance is particularly necessary for medical devices, such as x-ray devices or computer tomography devices, so that the best possible patient care can be provided.

A coupling device is known from 01/43238 A1 for transmission of data over a power supply network.

### SUMMARY OF INVENTION

An object of the invention is to overcome the disadvantages of the prior art. In particular a medical device and a method are to be specified which allow simple and especially reliable transmission of data.

This object is achieved by the claims. Useful embodiments of the invention emerge from the dependent.

In accordance with the invention a medical device is provided in which a data transmission device is provided for transmission of data between the control and/or monitoring device and a remote computer over the power network. A power network provided for supplying power to the medical device, e.g. a low-voltage network, can be used for transmission of the data. It is not absolutely necessary to provide specific data lines, telephone lines or such like. The transmission can be undertaken independently of faults in the data networks, e.g. defective radio connections, outages of Internet servers, routers or such like. Especially fault-free and reliable transmission of the data can be achieved. Data can especially also be transmitted to those medical devices in which a connection with existing data networks is not possible or only possible at great expense. The provision of the data transmission device enables an especially simple option for transmission of the data to be provided.

In accordance with an embodiment of the invention the control and/or monitoring device is connected to the data transmission device via a standard interface. The interface can for example be an RS232, a USB, an Ethernet interface and such like. The fact that standardized interfaces are used enables a very high level of compatibility and flexibility to be achieved with regard to a connection with the control and/or monitoring device. In particular an interface on an already installed control and/or monitoring device can be used. Expensive upgrading can be avoided.

One embodiment of the invention makes provision for the data transmission device to be connected to the control and monitoring device via a wireless connection, especially via a radio connection or an infrared connection. This is especially of advantage if the control and/or monitoring device is an element of a mobile component, such as a mobile detector of an x-ray device for example. Data lines would greatly restrict the handling of a mobile component.

In accordance with a further embodiment of the invention the control and/or monitoring device includes a processor, a microprocessor or a microcontroller. These can be used for control and monitoring purposes as well as for processing, further processing or evaluation of the transmitted data. Preferably the control and/or monitoring device is an element of a control and/or monitoring computer. The control and/or monitoring device can however also be provided for control and monitoring of individual components of the medical device.

In accordance with an especially preferred embodiment of the invention the power network is a public power supply network or is connected to this network. Use of or connection to the public power supply network allows remote maintenance of the medical device. The remote maintenance can for example be performed by the manufacturer of the medical device or by a service provider entrusted with the maintenance. Costly and time-consuming on-site maintenance work on the medical device can be reduced. It is especially possible for remote maintenance to be performed on medical devices which are not connected or cannot be connected to existing data networks, such as the Internet or a mobile radio network. Only a connection to the power network or the power supply network is required. For transmission of data between power networks separated geographically from one another, e.g. power networks on different continents, a data connection can be established between the power networks via a telephone network, the Internet or a mobile radio network.

In accordance with an embodiment of the invention the data contains exclusively control and/or monitoring-relevant data for the medical device. The data can for example be control data for operating the medical device. The data can also be software data, hardware data, error data or maintenance data. The transmission of control and/or monitoring-relevant data enables repair and maintenance intervals to be defined as well as remote maintenance of the medical device to be performed. Faults and errors can be detected at an early stage. The fact that the transmission over the power network is restricted to control and/or monitoring-relevant data makes it possible to separate data networks for control and/or monitoring-relevant data and networks for patient-specific data. Patient-specific data which is subject to data protection can be transmitted with a further data processing device, e.g. an Intranet or a local network, which is not accessible via the power network for data transmission purposes. A separation of the data networks enables access by unauthorized third parties to patient-specific data to be avoided. For example a service engineer entrusted with remote maintenance can be prevented from accessing patient-specific data. Data protection can be significantly improved.

In accordance with a further embodiment of the invention, a storage medium and/or data network independent of the power network is provided for patient-specific data. In this case the term independent is taken to mean that access to the data of the storage medium via the power network or a transmission of data between the power network and the data network is not possible. The fact that patient-specific data is not accessible via the power network or cannot be transmitted over this network enables especially high data protection standards to be achieved.

In accordance with an embodiment of the invention the medical device is a medical imaging device, preferably an x-ray device, a computer, an ultrasound or magnetic resonance computer tomography device.

In accordance with a another provision of the invention a medical installation is provided which comprises an inventive medical device for which the control and/or monitoring device is connected to a remotely-sited further computer for transmission of data. A power network already used for operating the medical installation can also be used for remote maintenance. The remote maintenance can be performed independently of data networks such as the Internet or mobile radio networks for example. This is especially advantageous if the medical device cannot be connected to the data networks or can only be connected to such networks at comparatively great expense. The data can essentially be transmitted independently of faults in the data network and therefore particularly safely and reliably.

In accordance with another provision of the invention a procedure is provided for remote maintenance of a medical device with the following steps:
Provision of a medical device connected to the power network, with the medical device comprising a control and/or monitoring device,
Provision of a computer sited remotely from the medical device connected to the power network or to a further power network and
Transmission of data between the control and/or monitoring device and the computer over the power network and if necessary the further power network by means of a data transmission device for transmission of data over the power network and if necessary the further power network.

### BRIEF DESCRIPTION OF THE DRAWINGS

The advantages of the inventive method and the embodiments of the method emerge analogously from the advantages of the inventive medical device described above.

The invention is explained below with reference to examples. The figures show:

FIG. 1 an inventive x-ray device and

FIG. 2 an inventive x-ray installation.

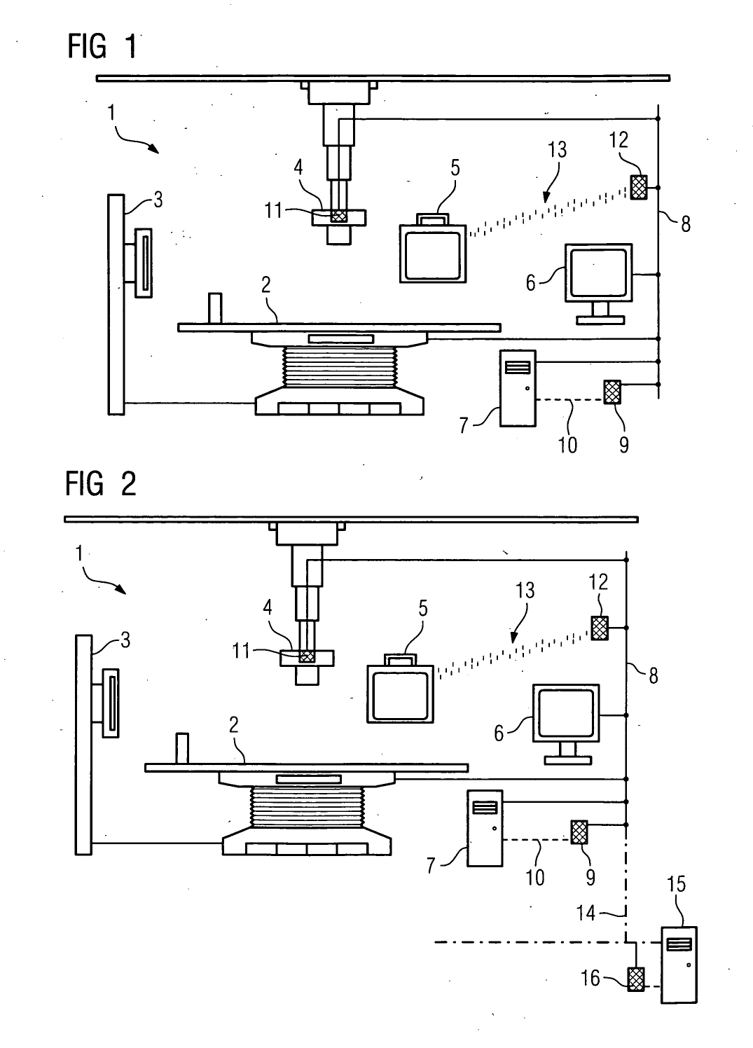

Features with the same function are identified by the same reference symbols in FIGS. 1 and 2.

### DETAILED DESCRIPTION OF INVENTION

FIG. 1 shows an inventive x-ray device 1. The x-ray device 1 features an x-ray tube 4 able to be positioned over a patient bed or on a vertical positioning device 3 by means of a floor support and a mobile detector 5. A computer 7 equipped with a monitor 6 is provided for control and operation of the x-ray device 1. The patient bed 2, the positioning device 3, the x-ray tube 4, the detector 5, the monitor 6 and also the computer 7 are supplied with electrical energy via a power network 8. A first data transmission device 9 connected to a power network 8 for transmitting data over the power network 8 is connected to the computer 7 via a connecting line 10. A second data transmission device 11 for transmission of data connected to the power network 8 is connected via the power network 8 to the x-ray tube 4. A third data transmission device 12 connected to the power network 8 for transmission of data over the power network 8 is connected via a radio connection 13 with the detector 5.

The function of the x-ray device 1 is as follows.

During operation of the x-ray device 1 data is transmitted between the computer 7, the detector 5 and a control of the x-ray tube 4 not shown on the basis of the first 9, second 11 and third data transmission device 12 via the power network. The transmission of the data can be both unidirectional and bidirectional. The data transmitted from the computer 7 to the control can be control and/or monitoring-relevant data such as parameter values, radiation duration and such like for example. It is also possible to transmit operating data of the control to the computer 7 for evaluation and monitoring purposes. For example the anode temperature or the anode current could be transmitted to the computer 7 and evaluated and monitored by the latter. A correct and secure operation of the x-ray device can be guaranteed by checking the operating data. Furthermore patient-specific data can also be transmitted. Patient-specific data can be data which is necessary for the examination of the patient. X-ray data recorded during an examination with the detector 5 can also be transmitted to the computer 7, for processing, image generation or for creation of a diagnosis for example. It is also possible only to transmit control and/or monitoring-relevant data over the power network 8. A transmission of patient-specific data can be transferred or stored for data protection purposes in a data network independent of the power network 8. It is also possible to transmit the data encrypted over the power network 8 for data protection purposes. The transmission or an access to the data over the power network 8 can also be undertaken under password protection. For transmission of control and/or monitoring-relevant data for remote maintenance for example, no further data networks such as the Internet or an Intranet is necessary, apart from the power network 8. Influences arising from additional faults or failures of the data network can largely be avoided. The data can be transferred especially securely and reliably.

The computer 7 can be connected to a first data transmission device 9 via a standard interface not shown. For example the interface can be an RS232, a USB or an Ethernet interface or similar. The second data transmission device 11 is provided as an integrated component of the controller. It is however also possible for the second data transmission device 11 to be connected to the control by a standard interface.

Data is transferred via a radio connection 13 between the detector 5 and the third data transmission device 12. Further transmission via the power network 8 is undertaken by the third data transmission device 12. The fact that the radio connection 13 is provided means that no data lines to the detector 5 are needed. This is especially of advantage if the detector 5 is operated by a rechargeable battery. The handling of the detector 5 is not adversely affected by additional connecting lines.

The control, the detector 3 as well as the computer 4 can be uniquely identified and addressed on the basis of an identification number assigned to them for transmission of data over the power network. To reduce the quantity of data transmitted this can be compressed prior to transmission.

The details given above provide a typical description of the transfer of data between the computer 7, the control of the x-ray tube 4 and the detector 5. However it is also possible for data to be transferred between any given components of the x-ray device, including the monitor 6, the patient bed 2 and the positioning device 3, a control of a diaphragm of the x-ray tube 4 or further components not shown and named. Furthermore the x-ray device 1 can be any given x-ray device 1, also an x-ray computer tomography device for example.

For the transmission of data over the power network 8 it is not necessary to install specific data lines to an existing data network. No additional data lines are needed in addition to the lines of the power network 8. The option for transferring data can be implemented especially simply. Furthermore the use of standard interfaces largely avoids the need to upgrade individual components.

FIG. 2 shows an inventive x-ray installation. The x-ray installation comprises the x-ray device 1 shown in FIG. 1 as well as a further computer 15 connected to a public power supply network 14, remote from the location of the x-ray device 1. The power supply network 14 is connected to the power network 8. The further computer 15 is connected via a fourth data transmission device 16 to the power supply network 14.

The function of the x-ray installation is as follows:

The fact that the power network 8 and the power supply network 14 are connected to each other enables data to be transmitted between the further computer 15 and components of the x-ray device 1, for example the patient bed 2, the positioning device 3, the control of the detector 5, the computer 7 etc., provided the components are connected to data transmission devices for transmission of data to the power network 8. The transmission of data between the further computer 15 and the x-ray device 1 can for example be used for remote maintenance and monitoring purposes. Software installed on the computer 7 can where necessary be updated by the further computer 15. Further more operating data of the x-ray device 1 can be interrogated, such as data of the x-ray tube 4 or of the detector 5 for example. On the basis of the interrogated data malfunctions can be detected or maintenance and repair work to be undertaken can be determined. An access to the x-ray device from the further computer 15 is possible at any time via the power network 8 and the power supply network 14. Remote maintenance can be performed especially reliably. The fact that the power network 8 and the power sup ply network 14 are used enables faults in remote maintenance and transmission errors to be largely avoided. An especially secure and smooth operation of the x-ray device 1 can be guaranteed.

The data can be stored in a data memory and for example interrogated or updated at fixed times, for example overnight or at weekends. When this is done the operation of the x-ray device 1 is disturbed as little as possible.

Of particular significance is the transmission of data over the power network 8 or a power supply network 14 for x-ray devices 1 which are difficult or impossible to reach via conventional data networks such as the Internet or mobile radio networks for example. It can be that the power network 8 and the power supply network 14 are not directly connected or cannot be connected. The transfer of the data between the x-ray device and the further computer 15 can in this case be undertaken as far as possible over the power network 8 or the power supply network 14. For transmission between the power network 8 and the power supply network 14 the data can be transmitted over already known data network, e.g. telephone lines, radio connections or such like. The number of accessible x-ray devices 1, for remote maintenance and monitoring purposes for example, can be increased.

For secure transmission of data between the further computer 15 and the x-ray device 1 the data can be encrypted. For example patient-specific data can be encrypted for data protection reasons. Furthermore an access from the further computer 15 to components of the x-ray device 1 or vice-versa can be password protected. To reduce the quantity of data transmitted this can be compressed prior to transmission.

In the embodiments of the invention described above the data is transmitted as far as possible over the power network 8 or the power supply network 14. The data can be transferred especially simply and reliably.

1-19. (canceled)

20. A medical device, comprising:
an electronic control and monitoring device for operating the medical device;
a data transmission device connected to the control and monitoring device for transmitting data between the control and monitoring device and a remotely-located computer, the data transmission device configured to transmit the data to the a remotely-located computer via a power line.

21. The medical device in accordance with claim 20, wherein the data transmission device is connected to the control and monitoring device by a standardized communication interface.

22. The medical device in accordance with claim 20, wherein the data transmission device is connected to the control and monitoring device by a wireless connection.

23. The medical device in accordance with claim 22, wherein the wireless connection is a radio or an infrared link.

24. The medical device in accordance with claim 20, wherein the control and monitoring device comprises a processor, a microprocessor or a microcontroller.

25. The medical device in accordance with claim 20, wherein the control and monitoring device is integrated into a control and monitoring computer or into a component of the medical device, the component of the medical device thus having at least two different functions including a function of controlling and monitoring the medical device.

26. The medical device in accordance with claim 20, wherein the power line is a public power supply network or is connected to a public power supply network.

27. The medical device in accordance with claim 20, wherein the data exclusively include control and monitoring-relevant data for the medical device.

28. The medical device in accordance with claim 20, further comprising a further data transmission device for transferring of data relating to a patient, the further data transmission device not accessible via the power line.

29. The medical device in accordance with claim 20, wherein the medical device is a medical imaging device.

30. A method for remote maintenance of a medical device, comprising:
providing a medical device;
connecting the medical device to a power line for transmitting data via the power line, the medical device comprising a control and monitoring device for operating the medical device;
providing a computer at a remote location relative to the medical device;
connecting the remote computer to the power line; and
transmitting the data between the control and monitoring device and the computer via the power line using a data transmission device configured to transmit data over power lines.

31. The method according to claim 30, wherein the data transmission device is connected to the control and monitoring device by a standardized communication interface.

32. The method in accordance with claim 30, wherein the data transmission device is connected to the control and monitoring device by a wireless connection.

33. The method in accordance with claim 30, wherein the control and monitoring device comprises a processor, a microprocessor or a microcontroller.

34. The method in accordance with claim 30, wherein the control and monitoring device is integrated into a control and monitoring computer or into a component of the medical device, the component of the medical device thus having at least two different functions including a function of controlling and monitoring the medical device.

35. The method in accordance with claim 30, wherein the power line is a public power supply network or is connected to a public power supply network.

36. The method in accordance with claim 30, wherein the transmitted data exclusively include control and monitoring-relevant data for the medical device

37. The method in accordance with claim 30, further comprising transmitting further data related to a patient, the further data transmitted by a further data transmission device not accessible via the power line.

38. The method in accordance with claim 30, wherein the medical device is a medical imaging device selected from the group consisting of an x-ray device, an x-ray ultrasonic device and a magnetic resonance computer tomography device.
